(19) United States
(12) Patent Application Publication
(10) Pub. No.: US 2016/0294561 A1
(43) Pub. Date: Oct. 6, 2016

(54) METHOD AND APPARATUS FOR DIGITALLY SIGNING A FILE

(71) Applicant: SIEMENS AKTIENGESELLSCHAFT, München (DE)

(72) Inventors: GERO BÄSE, MÜNCHEN (DE); WENRONG WENG, MÜNCHEN (DE)

(73) Assignee: Siemens Aktiengesellschaft, Munchen (DE)

(21) Appl. No.: 15/036,832

(22) PCT Filed: Oct. 21, 2014
(86) PCT No.: PCT/EP2014/072551

§ 371 Date: May 16, 2016

(30) Foreign Application Priority Data
Dec. 19, 2013 (DE) 10 2013 226 780.0

(51) Int. Cl. H04L 9/32; H04L 29/06

(52) U.S. Cl. CPC H04L 9/3247; H04L 63/06

(57) ABSTRACT

A method is provided for digitally signing a file that contains hierarchically structured data objects, the method including the steps of: generating at least one signature data object at the file level, calculating a digital signature for data from the file, and writing the calculated digital signature into the generated signature data object.

### CROSS-REFERENCE TO RELATED APPLICATIONS

This application claims priority to PCT Application No. PCT/EP2014/072551, having a filing date of Oct. 21, 2014, based off of DE Application No. 102013226780.0 having a filing date of Dec. 19, 2013, the entire contents of which are hereby incorporated by reference.

### FIELD OF TECHNOLOGY

The following relates to a method and an apparatus for digitally signing, particularly signing multiple times, a file that has hierarchically structured data objects.

### BACKGROUND

Digital signatures are used to establish the authenticity of electronically transmitted messages or electronic files or documents. By checking the digital signature, it is possible to establish whether these messages or files have been altered. The files to be signed normally have a few thousand bytes. In order to keep the computation time for forming a cryptographic checksum within acceptable limits, the checksum is usually not computed over the whole data string, but rather a hash function is first of all used to form a hash value by way of the data string to be signed. Hash functions are one-way functions for compressing data.

The files to be signed have a prescribed file structure. In the case of many file types, each file has hierarchically structured data objects. Particularly multimedia files that have an ISO base media file format contain hierarchically structured data objects that are also referred to as boxes. Hierarchically structured data objects of this kind offer a flexible extendible file format that facilitates interchange, file management, editing and presentation of the media data. The presentation of the data can take place locally or via a network or a data stream. In this case, the file format with the hierarchically structured file objects contained therein is designed such that it is independent of particular network protocols.

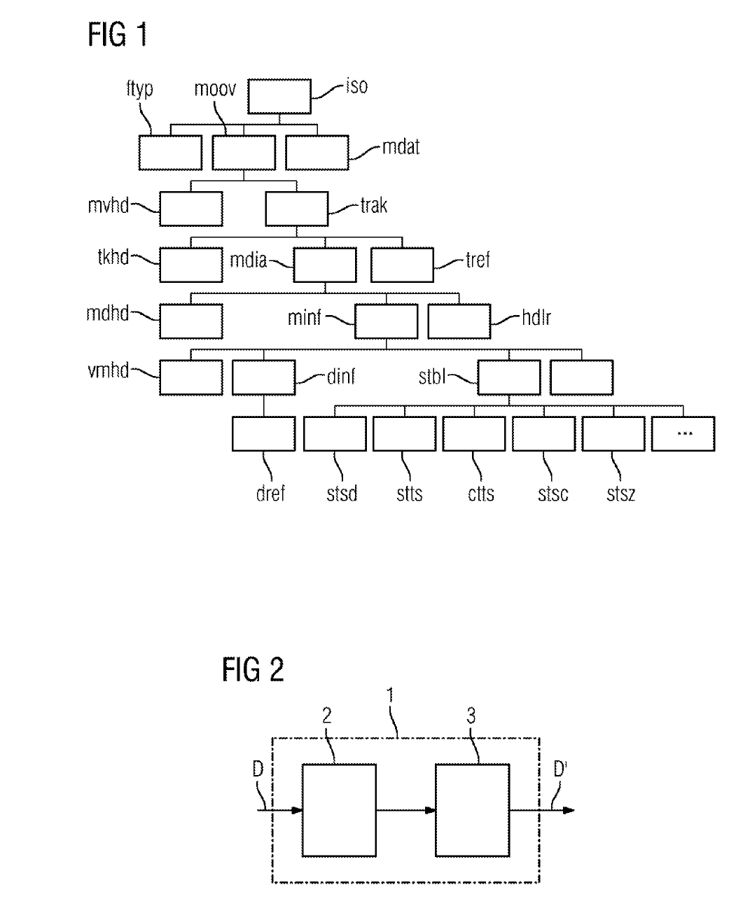

FIG. 1 schematically shows the file structure of a conventional media file that has hierarchically structured data objects or boxes. As can be seen in FIG. 1, the ISO base media file [1] shown on the topmost hierarchy level or file level comprises the file objects FTYP, MOOV, MDAT, etc. By way of example, the file object FTYP situated at file level indicates the file type of the file D. Furthermore, the file object can specify a file version and/or a compatibility with further ISO files. The file object MOOV that is likewise situated at file level is a file holder or container for the metadata of the respective presentation. The file object MDAT, which is likewise situated at file level, contains the media data or useful data of the media file.

As can be seen in FIG. 1, the various data objects are hierarchically structured, the topmost hierarchy level being formed by the file level. The file objects on the topmost hierarchy level can for their part consist of hierarchically structured file objects, as shown in FIG. 1. Thus, by way of example, the file object MOOV that comprises the metadata of the presentation has a file object MVHD (Movie Header). The file object MVHD (Movie Header) contains header or management data that are generic for the respective film or movie. The file object TRAK forms a file holder for metadata that relate to a data stream. Each file object may itself be hierarchically broken down further, as shown in FIG. 1.

Yongdong, Wu et al.: “Scalable authentication of MPEG-4 streams”, IEEE Transactions on Multimedia, Volume 8, issue 1, describes multiple authentication methods for MPEG-4 data streams. All the authentication methods proposed each require just a single digital signature for a compressed MPEG-4 object group.

In many instances of application, it is desirable for files to be signed multiple times by various entities or units. In a release process for a film, for example, it is necessary for the film or movie to be released or signed by different offices within the production company and also by various authorities. A further application example is evidence files in court proceedings. If a file, particularly a video file, contains evidence that may be relevant to a lawsuit, for example, the file can first of all be signed by the investigating officer and then forwarded to the public prosecution department, for example, which for its part signs the received file and finally forwards it to a receiving office at the court as relevant evidence, with the receiving office at the court for its part possibly signing the file received from the public prosecution department. In many instance of application, it is therefore necessary for a file, particularly a media file, to be signed multiple times by various entities in a chain, the number of signing entities possibly varying. In many cases, it is also not certain how many entities in the chain will sign the file. With conventional methods of signing, it is not possible for hierarchically structured file objects to be signed multiple times. A reason for this is that when new content is added, the interleaved data objects of the file require the magnitudes of the superordinate data objects or mother boxes to be aligned, which makes it impossible to check a signing that has already taken place.

### SUMMARY

An aspect relates to a method and an apparatus for digitally signing a file that has hierarchically structured data objects that allow the file to be signed multiple times.

In one possible embodiment of the method according to embodiments of the invention, the digital signature is computed for all or at least some of the data of the file, including the at least one generated signature data object.

In one possible embodiment of the method according to the invention, a signature data object comprises

an identifier for identifying the signature data object,
a data magnitude of the signature data object,
a reference list that contains references to signature data objects that there are already within the file, and
a memory area for writing the computed digital signature to the signature data object.

In a further possible embodiment of the method according to the invention, the digital signature is computed by computing a value, particularly a hash value, for the data of the file and encrypting the computed value by means of a cryptographic key to form the digital signature.

In a further possible embodiment of the method according to the invention, the file to be signed is first of all parsed to determine whether there is already a signature data object at file level.

In a further possible embodiment of the method according to the invention, if there are already signature data objects in the file to be signed, that signature data object that has the longest reference list is selected and its reference list is extended with the identifier of the generated signature data object as reference.

In a further possible embodiment of the method according to the invention, the signature data object has a time statement indicating the time of production of the signature data object.

In a further possible embodiment of the method according to the invention, the signature data object has a time statement indicating the time of production of the digital signature stored therein.

In a further possible embodiment of the method according to the invention, in the reference list of a signature data object, the digital signature produced first and/or the order of the digital signatures produced and/or the digital signature produced last is identifiable, particularly on the basis of the time statements.

In a further possible embodiment of the method according to the invention, the file to be signed has an ISO base media file format.

In a further possible embodiment of the method according to the invention, the file to be signed is signed multiple times by various signing units, wherein a method for digitally signing the file is performed sequentially for each signing unit, said method comprising the following steps:

generating at least one signature data object at file level,
computing a digital signature for data of the file and
writing the computed digital signature to the generated signature data object.

In a further possible embodiment of the method according to the invention, a determined digital signature of the file signed multiple times is verified independently of the other digital signatures that there are within the file.

In one possible embodiment of the method according to the invention, the independent verification of a determined digital signature of the file signed multiple times is effected by virtue of all signature data objects whose reference list is longer than the reference list of the data object to be verified in which the determined digital signature to be verified is located being rejected and a value, particularly a hash value, being computed for all or at least some of the remaining files of the file signed multiple times, which value is used to verify the digital signature by comparing said value with a comparison value that is computed by decrypting the digital signature by means of a cryptographic key.

In a further alternative embodiment of the method according to the invention, the independent verification of a determined digital signature of the file signed multiple times is effected by virtue of the signature data objects whose time statement is older than that of the signature data object to be verified being rejected and a value, particularly a hash value, being computed for all or at least some of the remaining data, which value is used to verify the digital signature by comparing said value with a comparison value that is computed in order to decrypt the digital signature by means of a cryptographic key.

In one possible embodiment of the method according to the invention, if the computed value matches the comparison value, then the digital signature of the file is recognized as valid.

Embodiments of the invention additionally provide an apparatus for digitally signing a file.

In one possible embodiment of the apparatus according to the invention, the generated signature data object comprises

an identifier for identifying the signature data object,
a data magnitude of the signature data object,
a reference list that contains references to signature data objects that there are already within the file, and
a memory area for writing the computed digital signature to the signature data object.

In a further possible embodiment of the apparatus according to the invention, the computation unit computes the digital signature by computing a value, particularly a hash value, for all or least some of the data of the file and forms the digital signature by encrypting the computed value by means of a cryptographic key.

In a further possible embodiment of the apparatus according to the invention, the apparatus contains a parser unit that parses the file to be signed to determine whether there is already a signature data object at file level,

wherein if there are already signature data objects in the file to be signed, then that signature data object that has the longest reference list is selected and its reference list is extended with the identifier of the generated signature data object as reference or its reference list is extended with the identifier of the selected signature data object as reference.

In one possible embodiment of the apparatus according to the invention, the signature data object has at least one time statement indicating the time of production of the signature data object and/or of production of the digital signature stored therein.

In a further possible embodiment of the apparatus according to the invention, in the reference list of a signature data object, the digital signature produced first and/or the order of the digital signatures produced and/or the digital signature produced last is identifiable, particularly on the basis of the time statements.

In a further possible embodiment of the apparatus according to the invention, the file to be signed has an ISO base media file format.

### BRIEF DESCRIPTION

Some of the embodiments will be described in detail, with reference to the following figures, wherein like designations denote like members, wherein:

FIG. 1 shows a file structure for a conventional media file based on the prior art;

FIG. 2 shows a block diagram of a possible embodiment of the apparatus for digitally signing a file;

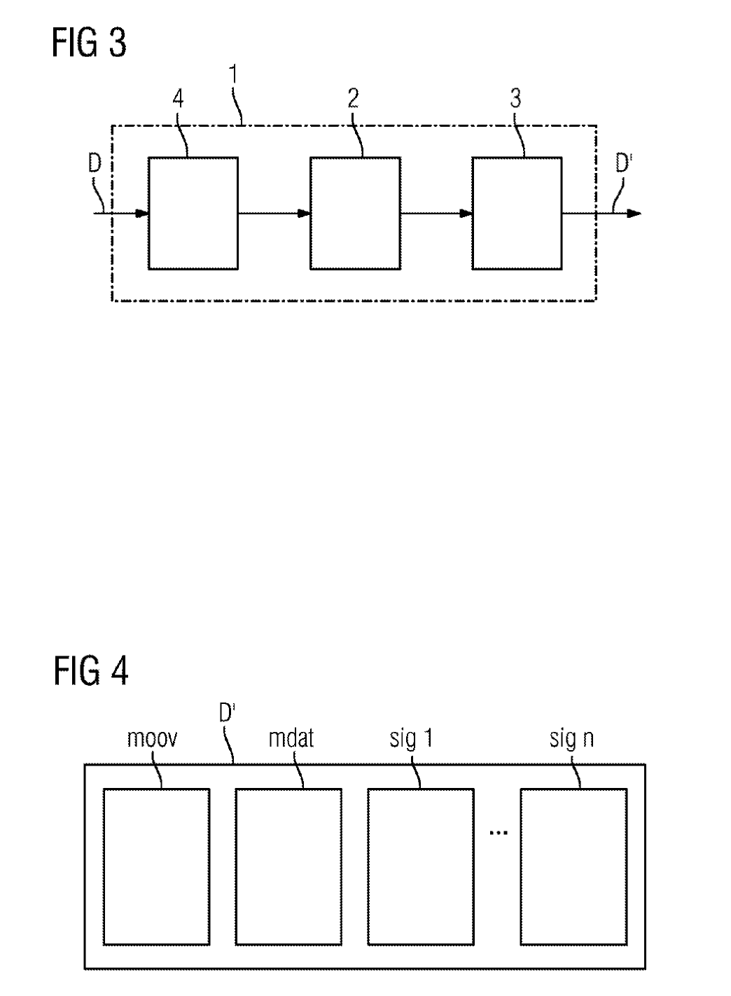

FIG. 3 shows a block diagram of a possible embodiment of the apparatus for digitally signing a file;

FIG. 4 shows a diagram to illustrate a possible data structure for a file digitally signed using the method or the apparatus according to embodiments of the invention;

FIG. 5 shows a diagram to illustrate an exemplary embodiment of a signature data object used for the method and the apparatus;

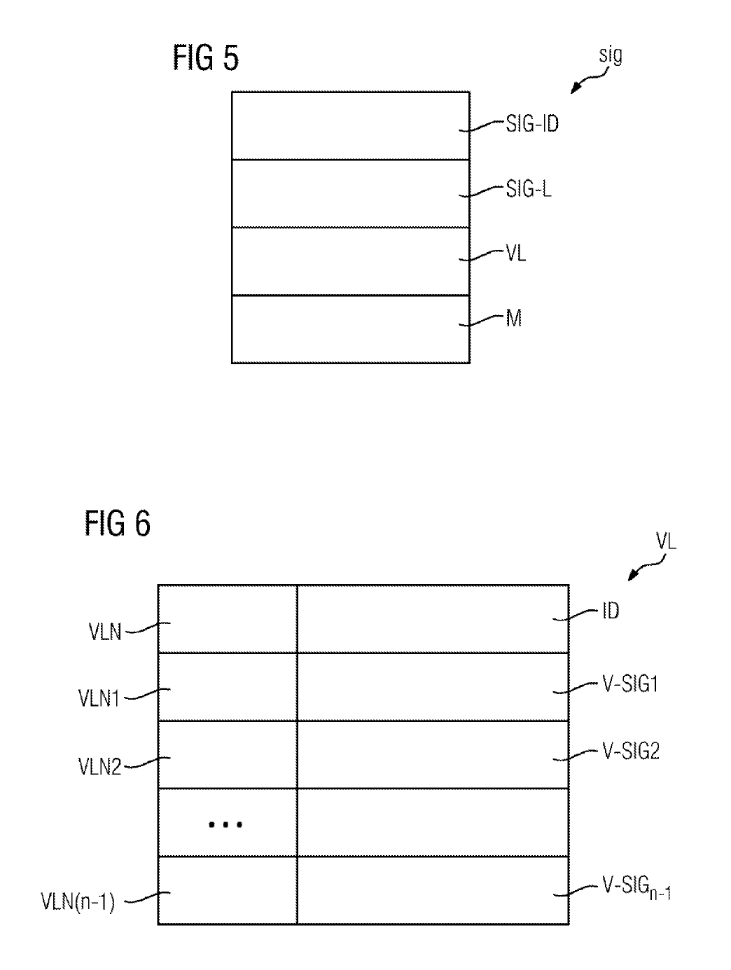

FIG. 6 shows a diagram to illustrate a possible embodiment of a reference list within a signature data object;

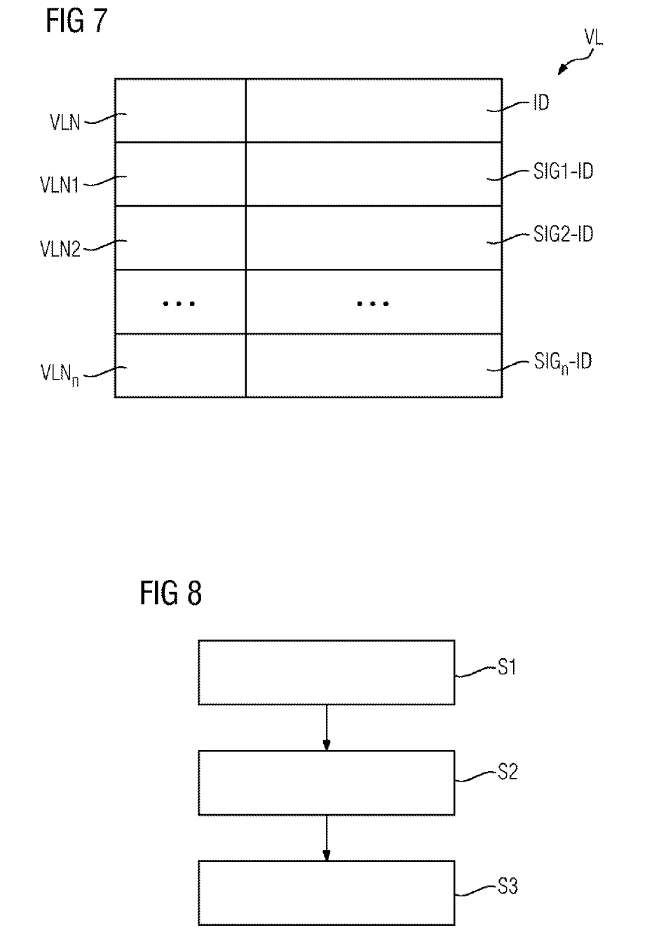

FIG. 7 shows a diagram to illustrate a possible further embodiment of a reference list within a signature data object;

FIG. 8 shows a flowchart to illustrate an exemplary embodiment of a method for digitally signing a file.

### DETAILED DESCRIPTION

As can be seen from FIG. 2, an apparatus 1 for digitally signing a file that has hierarchically structured data objects contains, in the exemplary embodiment shown, a generation unit 2 and a computation unit 3. The generation unit 2 generates at least one signature data object at file level for the file to be signed. The computation unit 3 then computes a digital signature for data of the file, the computed digital signature being written to the signature data object of the file that has been generated by the generation unit 2.

The file to be signed may be a media file that has hierarchically structured data objects. In one possible embodiment, the file to be signed has an ISO base media file format [1]. The ISO base media file format contains what are known as boxes that are hierarchically structured. An example of a file D to be signed that comprises hierarchically structured data objects is shown in FIG. 1. In this case, the file structure is preferably object-oriented. The file can easily be broken down into base objects, the data structure of the data objects being implied by the file type. The files that correspond to the ISO base media file format are formed by a series of data objects that are also referred to as boxes. The data are contained in the file boxes. A file box or a data object forms an object-oriented data block that can be defined by an identifier and a specified length or magnitude. A presentation may be contained in multiple files. The time statements and frame information are contained in the ISO base media file format. In one possible embodiment, the file D to be signed is a media file based on the ISO base media file format, for example an mp4 file. The ISO base media file format supports both the streaming of media data via a network and the local reproduction of the media data. Further possible examples of files that have an ISO base media file format are 3GP files or JPEG files.

The files D to be signed can be stored in a buffer store and supplied to the apparatus 1, which is shown in FIG. 2, for digital signing. The generation unit 2 of the apparatus 1 generates a signature data object SIG at file level, i.e. on the topmost hierarchic level of the file. In one possible embodiment, this signature data object has an identifier for identifying the signature data object. Furthermore, the signature data object SIG contains, in one possible embodiment, a statement about the data magnitude of the signature data object. In addition, the signature data object SIG can contain a reference list VL. In one possible embodiment, this reference list VL contains references to signature data objects that there are already within the file D. In a further possible embodiment, the identifier of the signature data object itself may also be contained within the reference list VL. Furthermore, the signature data object has a memory area for writing the computed digital signature to the signature data object SIG.

To produce or generate the signature data object, the computation unit 3 computes a value, preferably a hash value H, by way of data of the file D to be signed and then encrypts the computed value, particularly the hash value, by means of a cryptographic key K to form the digital signature.

In one possible embodiment, the digital signature is computed by the computation unit 3 for all or at least some of the data of the file, including the at least one generated signature data object SIG. In one possible embodiment, the bits or memory areas into which the digital signature is later entered are set to a predefined value, for example to the value 0. This predefined value is included in the computation of the digital signature and replaced at the end by the actual digital signature that is produced by the computation unit 3. In an alternative embodiment, the bits into which the digital signature is later entered are precluded for computation by the computation unit 3.

In one possible embodiment, the computation unit 3 has at least one microprocessor for performing the computation. This microprocessor computes a digital signature for data of the file D to be signed and then writes the computed digital signature to the generated signature data object that is produced by the generation unit 2. In one possible embodiment, the computation unit 3 has access to a cryptographic key K that is stored in a protected memory area, for example. In one possible embodiment, the computation unit 3 uses a hash function to compute a hash value H for all or at least some of the data of the file D to be signed and then encrypts the computed hash value H by means of the read cryptographic key K to form the digital signature, which is then written to the memory area provided for this purpose in the signature data object SIG formed by the generation unit 2.

The file D′ digitally signed by the apparatus 1 can be transmitted via a transmission channel to a receiver that verifies the digital signature. In a further possible embodiment, the signed file D′ can be transmitted to a further apparatus 1 that digitally signs the already signed file D′ again. In this embodiment, an originally produced file D that has hierarchically structured data objects can be signed multiple times successively or sequentially by various apparatuses 1. In a further possible embodiment, the signed file D′ produced by the computation unit 3 is fed back and is signed multiple times by the same apparatus 1. In this embodiment, various users can use the same apparatus 1 to sign an originally present file multiple times, for example. Alternatively, various users each have a dedicated apparatus 1, which is shown in FIG. 2. By way of example, various departments within an organization or a company each have apparatuses 1 that each have a generation unit 2 and a computation unit 3.

FIG. 3 shows a block diagram of a further embodiment of the apparatus 1 according to the invention for digitally signing a file. In this embodiment, the apparatus 1 additionally has, on the input side, a parser unit 4 that parses the file D to be signed to determine whether there is already a signature data object at file level. In one possible embodiment, if there are already signature data objects in the file D to be signed, that signature data object that has the longest reference list VL is selected and its reference list is extended with the identifier of the generated signature data object as reference.

In one possible embodiment of the apparatus according to the invention, a signature data object has at least one time statement indicating the time of production of the signature data object and/or of production of the digital signature stored therein. In the reference list VL of a signature data object, the digital signature produced first and/or the order of the digital signatures produced and/or the digital signature produced last is identifiable. In one possible embodiment, this is possible on the basis of the time statements that the signature data object contains.

The file D to be signed is signed multiple times by various units or the same unit, each signing unit first of all generating a signature data object at file level and then computing a digital signature for data of the file that is written to the generated signature data object. In this case, a determined digital signature of the file signed multiple times can be verified independently of the other digital signatures that there are within the file. In one possible embodiment, this involves signature data objects whose reference list VL is longer than the reference list of the signature data object to be verified in which the determined digital signature to be verified is situated being rejected and a value, particularly a hash value H, being computed for all or at least some of the other data of the file signed multiple times. This computed value, particularly hash value, is then used to verify the digital signature by comparing said value with a comparison value that is computed by decrypting the digital signature by means of a cryptographic key K. If the computed value matches the comparison value, then the digital signature of the file is recognized as valid.

In a further possible embodiment, the digital signature is verified by virtue of signature data objects whose time statement is older than that of the signature data object to be verified being rejected and a value, particularly a hash value H, being computed for all or at least some of the other data of the file signed multiple times, which value is used to verify the digital signature by comparing said value with a comparison value that is computed by decryption of the digital signature by means of a cryptographic key K. Provided that the computed value matches the comparison value, the digital signature of the file is recognized as valid.

In one possible embodiment, the time statement comprises a date and a time of day. In one possible embodiment, the time statement is produced by a timer of the apparatus 1. In one possible embodiment, the timer of the apparatus 1 produces a time stamp or a time statement indicating the time of production of the signature data object by the generation unit 2 and/or the time for computation of the digital signature by the computation unit 3. The method according to embodiments of the invention can be used to verify inner and outer digital signatures at any time independently of one another. The order of verification of the various digital signatures that are stored in the various generated signature data objects is therefore variable. The various digital signatures can be verified by the same or different units or entities. In the case of the apparatus 1 according to embodiments of the invention, the computation unit 3 can use symmetric or asymmetric decryption methods.

FIG. 4 shows the data structure of a file D′ digitally signed by the apparatus according to embodiments of the invention. In the example shown in FIG. 4, the original file D comprises two data objects on the topmost hierarchy level or file level, namely the file object MOOV, in which the metadata of the presentation are situated, and the file object MDAT, which contains the actual media data or useful data. Further data objects on the hierarchically topmost level, i.e. the file level, are possible, for example a file object FTYP that indicates the file type and the file version. In the case of the method according to embodiments of the invention and the apparatus 1 according to embodiments of the invention, signature data objects SIG are generated at file level, as shown in FIG. 4. The multiple signing involves multiple signature data objects SIG1, SIG2 . . . SIGn being successively generated, the production of a signature data object SIGi being followed by a digital signature being computed and being written to the generated signature data object. The number of multiple signings is variable and unlimited. The various signature data objects each contain a reference list VL.

The containers or boxes or signature data objects may be embodied such that already existing definitions of box structures, for example ONVIF, can be adopted. In addition, the containers or boxes or signature data objects can be embodied such that signatures as are used for e-mail (RFC1847), for example, can be inserted directly. A container can therefore have a prescribed data structure. In one possible embodiment, each generated signature data object has not only the reference list VL but also a dedicated memory area or container for writing the computed digital signature to the signature data object.

FIG. 5 shows a possible data structure of a signature data object SIG generated by the generation unit 2. In the exemplary embodiment shown, the signature data object has an identifier for identifying the signature data object, a file size or file length SIG-L of the signature data object and a reference list VL. The reference list VL can contain references to signature data objects that there are already within the file. Furthermore, the signature data object SIG in the exemplary embodiment shown in FIG. 5 has a memory area in which the computed digital signature of the signature data object can be written.

FIG. 6 shows the design of a reference list, VL, within a signature data object, SIG, in a possible variant of the method according to embodiments of the invention. In the exemplary embodiment shown, the reference list VL contains multiple entries, namely a reference list number 1, 2 . . . n−1 and a respective reference to an associated signature data object (V-SIGi). For n signature boxes or n signature data objects, the reference list VL in the exemplary embodiment shown in FIG. 6 therefore contains n−1 entries, each of which has a reference to an associated signature data object that there is already within the file.

FIG. 7 shows a further exemplary embodiment for a reference list, VL, situated within a signature data object, SIG. In this exemplary embodiment, the reference list, VL, contains an ordered ID list of signature data objects that there are within the file. In the exemplary embodiment shown in FIG. 7, the reference list VL of the signature data object therefore contain n entries that each have a corresponding reference list number and specify an identifier for an associated signature data box or an associated signature data object. In the exemplary embodiment shown in FIG. 7, the first signature box has a reference list, VL, with just a single entry, namely its own signature box identification. The second signature box or the generated second signature data object has a reference list VL with two entries, namely the ID of the first signature box and its own signature box ID. Accordingly, the n-th signature box, as shown in FIG. 7, has a reference list VL with n entries, namely the IDs of the remaining signature boxes and its own ID.

The references or entries that the reference lists VL contain may be embodied differently. In one possible embodiment, the references have links or pointers to the respective signature box or the respective signature data object.

FIG. 8 shows a flowchart for a possible embodiment of the method according to embodiments of the invention for digitally signing a file D that comprises hierarchically structured data objects.

In a first step S1, at least one signature data object SIG is generated at file level.

In a further step S2, a digital signature is computed for data of the file. In this case, in one possible embodiment, the digital signature is computed for all or at least some of the data of the file, including the at least one signature data object generated in step S1.

In a further step S3, the computed digital signature is written to the generated signature data object SIG. In this case, the digital signature is preferably written or copied in a memory area M provided for this purpose in the signature data object produced.

To compute the digital signature in step S2, in one possible embodiment, a value, particularly a hash value H, is first of all computed for all or at least some of the data of the file and then the value is encrypted by means of a cryptographic key K to form the digital signature. The digital signature formed in this manner is then written to the generated signature data object SIG in step S3.

In one possible embodiment of the method shown in FIG. 8, the file to be signed is first of all parsed prior to step S1 in order to check whether there is already a signature data object at file level in the file D. If there are already one or more signature data objects in the file D to be signed, then in one possible embodiment, that signature data object that has the longest reference list VL is selected and its reference list is extended with the identifier of the generated signature data object as reference. Alternatively, the reference list VL is extended with the identifier of the selected signature data object. The process shown in FIG. 8 can be performed multiple times in a loop. In this case, the file to be signed is signed multiple times particularly by various signing units, the progression shown in FIG. 8 being performed sequentially for each signing unit. The file signed multiple times in this manner can then be verified, for example after a data transmission has taken place, in respect of the digital signatures that it contains. In this case, the various digital signatures of the file signed multiple times can be verified independently of one another in any order. In one possible embodiment of the method according to the invention, signature data objects whose reference list VL is longer than the reference list of the signature data object to be verified in which the determined digital signature to be verified is situated are first of all rejected and then a value, particularly a hash value, is computed for all other data of the file signed multiple times, which value is used to verify the digital signature by virtue of said value being compared with a comparison value that is computed by decryption of the digital signature by means of a cryptographic key K. Only if the computed value matches the comparison value is the digital signature of the file recognized as valid.

In a further possible embodiment of the method according to the invention, a determined digital signature of the file signed multiple times is verified by first of all evaluating the time statements of the signature data objects. In this variant embodiment, all signature data objects whose time statement is older than that of the signature data object to be verified are first of all rejected and a value, particularly a hash value H, is computed for all or at least some of the remaining data of the file signed multiple times, which value is used to verify the digital signature by virtue of said value being compared with a comparison value that is computed by decryption of the digital signature by means of a cryptographic key K. If the computed value matches the comparison value, then the digital signature of the file is recognized as valid in this variant embodiment.

The data transmitted in the verified file can then be evaluated or can be output via an output unit. Transmitted audio-visual data of a media file are output to a user via an audio-visual output unit. The method according to embodiments of the invention allows multiple signing with digital signatures in a signature chain without preceding intervention in the data content of the file. The method according to embodiments of the invention allows digital signatures to be inserted into a multimedia file without the need for existing data content to be altered. In the case of the method according to embodiments of the invention, each digital signature uses a freshly generated associated signature box or an associated signature data object. A signature data object that has been produced has an associated box ID or identifier. In this case, the identifier may be situated outside or inside a reference list VL of the signature data object SIG. By way of example, a box ID used may be the serial number of a certificate issued by a certification center, or a key ID when a PGP encryption method is used.

In one possible embodiment, the signature data object generated in the method according to the invention can also be stored and/or used separately from the file. The reference list VL generated in the method according to embodiments of the invention for a signature data object that comprises references to existent digital signatures allows applications in which the order of the digital signatures is significant. The reference list with the digital signatures that it contains additionally makes it difficult for third parties to introduce incorrect or forged digital signatures into the system without this being recognized.

The method according to embodiments of the invention and the apparatus according to embodiments of the invention for digitally signing a file can be used for any hierarchically structured data objects that need to be signed multiple times, depending on the application.

Although the present invention has been disclosed in the form of preferred embodiments and variations thereon, it will be understood that numerous additional modifications and variations could be made thereto without departing from the scope of the invention.

For the sake of clarity, it is to be understood that the use of ‘a’ or ‘an’ throughout this application does not exclude a plurality, and ‘comprising’ does not exclude other steps or elements.

### LIST OF REFERENCES

[1] ISO/IEC 14496-12, Information technology—Coding of audio-visual objects—Part 12: ISO base media file format, 4^{th} edition, 2012

1. A method for digitally signing a file, that has hierarchically structured data objects, comprising:
(a) generating at least one signature data object at file level;
(b) computing a digital signature for data of the file (D); and
(c) writing the computed digital signature to the at least one generated signature data object;
wherein the file to be signed is signed multiple times, and wherein for every signing, a signature data object is first of all generated at file level and then a digital signature is computed for data of the file and is written to the at least one generated signature data object.

2. The method as claimed in claim 1, wherein the digital signature is computed for data of the file, including the at least one generated signature data object.

3. The method as claimed in claim 1, wherein a signature data object includes:
an identifier for identifying the signature data object;
a data magnitude of the signature data object;
a reference list that contains references to signature data objects that there are already within the file; and
a memory area for writing the computed digital signature to the signature data object.

4. The method as claimed in claim 1, wherein the digital signature is computed by computing a value, particularly a hash value, for the data of the file and encrypting the computed value by means of a cryptographic key to form the digital signature.

5. The method as claimed in claim 1, wherein the file to be signed is first of all parsed to determine whether there is already a signature data object at file level.

6. The method as claimed in claim 5, wherein if there are already signature data objects in the file to be signed, that signature data object that has the longest reference list is selected and its reference list is extended with the identifier of the generated signature data object as reference or its reference list is extended with the identifier of the selected signature data object as reference.

7. The method as claimed in claim 1, wherein the signature data object has a time statement indicating the time of production of the signature data object and/or of production of the digital signature stored therein.

8. The method as claimed in claim 1, wherein in the reference list of a signature data object,
the digital signature produced first and/or
the order of the digital signatures produced and/or
the digital signature produced last is identifiable, particularly on the basis of the time statements.

9. The method as claimed in claim 1, wherein the file to be signed has an ISO base media file format.

10. The method as claimed in claim 1, wherein the file to be signed is signed multiple times by various signing units, and the method is performed sequentially for each signing unit.

11. The method as claimed in claim 10, wherein a determined digital signature of the file signed multiple times is verified independently of the remaining digital signatures that there are within the file by virtue of signature data objects whose reference list is longer than the reference list of the signature data object to be verified in which the determined digital signature to be verified is located or by virtue of all of the signature file objects whose time statement is older than that of the signature file object to be verified being rejected and a value, particularly a hash value, being computed for at least some of the remaining data of the file signed multiple times, which value is used to verify the digital signature by comparing said value with a comparison value that is computed by decrypting the digital signature by means of a cryptographic key.

12. The method as claimed in claim 11, wherein if the computed value matches the comparison value, then the digital signature of the file is recognized as valid.

13. An apparatus for digitally signing a file that has hierarchically structured data objects, comprising:
a generation unit for generating at least one signature data object at file level;
a computation unit for computing a digital signature for data of the file;
wherein the computed digital signature is written to the generated signature data object,
wherein the apparatus is designed to sign the file to be signed multiple times, and
wherein the apparatus first of all generates a signature data object at file level for every signing and then computes a digital signature for data of the file that is written to the generated signature data object.

14. The apparatus as claimed in claim 13, wherein a signature data object includes:
an identifier for identifying the signature data object,
a data magnitude of the signature data object,
a reference list that contains references to signature data objects that there are already within the file, and
a memory area for writing the computed digital signature to the signature data object.

15. The apparatus as claimed in claim 13, wherein the computation unit computes the digital signature by computing a value, particularly a hash value, for data of the file and forms the digital signature by encrypting the computed value by means of a cryptographic key.

16. The apparatus as claimed in claim 13, wherein a parser unit is provided that parses the file to be signed to determine whether there is already a signature data object at file level, wherein if there are already signature data objects in the file to be signed, then that signature data object that has the longest reference list is selected and its reference list is extended with the identifier of the generated signature data object as reference.

17. The apparatus as claimed in claim 13, wherein the signature data object has a time statement indicating the time of production of the signature data object and/or of production of the digital signature stored therein.

18. The apparatus as claimed in claim 13, wherein in the reference list of a signature data object, the digital signature produced first and/or the order of the digital signatures produced and/or the digital signature produced last is identifiable, particularly on the basis of the time statements.

19. The apparatus as claimed in claim 13, wherein the file (D) to be signed has an ISO base media file format.
